(19) United States
(12) Patent Application Publication
(10) Pub. No.: US 2012/0330671 A1
(43) Pub. Date: Dec. 27, 2012

(54) SYSTEM AND METHOD FOR IMPLEMENTING CONGESTION PRICING IN A POWER DISTRIBUTION NETWORK

(75) Inventors: Jiyuan Fan, Duluth, GA (US); Jason Wayne Black, Clifton Park, NY (US); Bernard Jacques Lecours, Atlanta, GA (US); Nathan Bowman Littrell, Gardnerville, NV (US); Rajesh Tyagi, Niskayuna, NY (US)

(73) Assignee: GENERAL ELECTRIC COMPANY, Schenectady, NY (US)

(21) Appl. No.: 13/166,484

(22) Filed: Jun. 22, 2011

(51) Int. Cl. G06Q 50/00

(52) U.S. Cl. 705/1.1

(57) ABSTRACT

A system for implementing congestion pricing in a power distribution network includes a monitoring and control engine configured to receive an actual power consumption value for a node in the power distribution network and a congestion engine coupled to the monitoring and control engine configured to determine that a power consumption value exceeds a capacity related set point of the node. The system further includes a pricing calculator that establishes a congestion price for power to be applied while the actual power consumption value exceeds the set point of the node and a credit calculator that provides credits to consumers coupled to the node that consume power at a rate below a threshold while the actual power consumption value exceeds the set point of the node.

### BACKGROUND OF THE INVENTION

The subject matter disclosed pricing of a commodity and, in particular, pricing of electricity during times of high use.

Electrical power can be generated in several different manners. For instance, the power can be generated by a nuclear reactor, wind powered turbines and gas or steam turbines. The cost of operating these different types of power generators can vary. Generally, during normal usage, the primary source of power can meet all of the demands for a particular distribution network. Instances may arise where demand exceeds the production capabilities of the primary power source. In such instances additional power sources must be brought on line or power must be purchased from another supplier. Regardless, the power production during these instances is typically not as efficient.

In other cases, the primary power source can provide sufficient power to the distribution network but a particular node of the network may experience demand that is beyond its rated capacity. Such a case can be referred to herein as a “localized overload condition.” Currently there are two methods that can be used to deal with a localized overload condition. The first is to shed load to one or more of the consumers coupled to the node. The second is to utilize direct load control where certain devices at the consumer are under the control of the power producer and can be turned off by the producer. Each of these approaches is inefficient and denies the consumer a choice. Further, in some instances loads that are shed or controlled may be more valuable/critical than other potential load reductions available at the same time or may go beyond the amount of load reduction necessary to address the overloads. Alternatively, utilities can allow some overload conditions to persist, but this can severely reduce the lifetime of the overloaded equipment and increase operations and maintenance costs.

### BRIEF DESCRIPTION OF THE INVENTION

According to one aspect of the invention, a system for implementing congestion pricing in a power distribution network is disclosed. The system of this aspect includes a monitoring and control engine configured to receive an actual power consumption value for a node in the power distribution network and a congestion engine coupled to the monitoring and control engine configured to determine that a power consumption value exceeds a capacity related set point of the node. The system of this aspect further includes a pricing calculator that establishes a congestion price for the power to be applied while the actual power consumption value exceeds the set point of the node and a credit calculator that provides credits to consumers coupled to the node that consume power at a rate below a threshold while the actual power consumption value exceeds the set point of the node.

According to another aspect of the invention, a method for implementing congestion pricing in a power distribution network is disclosed. The method of this aspect includes: receiving an actual power consumption value for a node in the power distribution network; determining that a power consumption value exceeds a set point of the node; establishing a congestion price for power to be applied while the actual power consumption value exceeds the set point of the node; and providing credits to consumers coupled to the node that consumes power at a rate below a threshold while the actual power consumption value exceeds the set point of the node.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an example of a power production and distribution network;

FIG. 2 is a block diagram of a pricing monitor according to one embodiment of the present invention;

FIG. 3 is a flow chart showing a method according to one embodiment of the present invention; and

FIG. 4 shows a computing system on which embodiments of the present invention may be implemented.

The detailed description explains embodiments of the invention, together with advantages and features, by way of example with reference to the drawings.

### DETAILED DESCRIPTION OF THE INVENTION

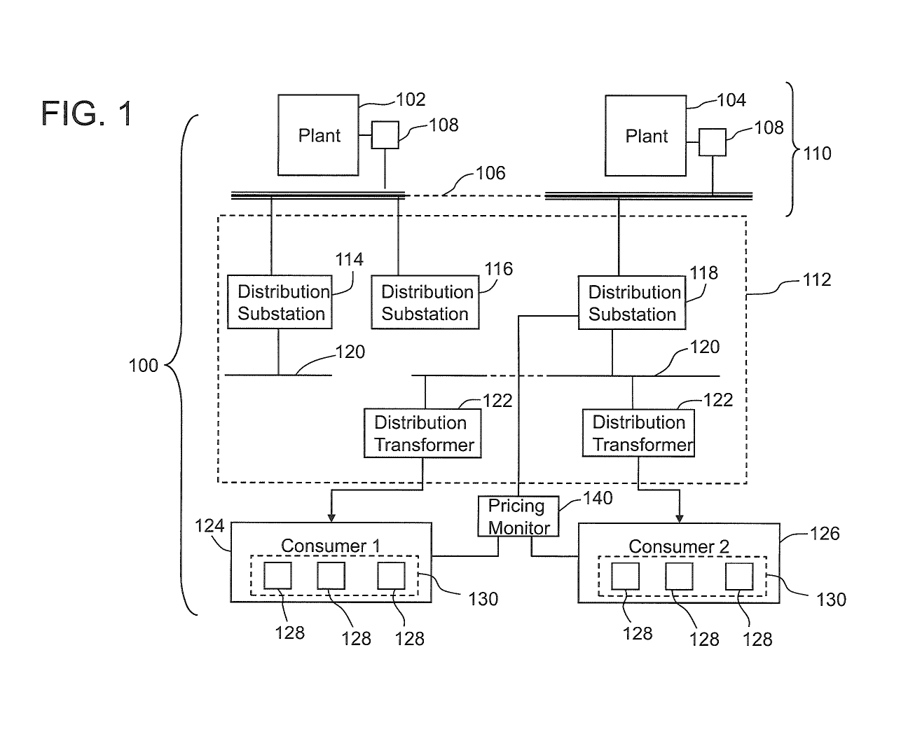

Referring now to FIG. 1, a production and distribution system 100 is illustrated. The system 100 includes one or more power plants 102, 104 connected in parallel to a main transmission system 106 by multiple step-up transformers 108. The power plants 102, 104 may be coal, nuclear, natural gas, incineration power plants or a combination thereof. Additionally, the power plants 102, 104 may include one or more hydroelectric, solar, or wind turbine power generators. The step-up transformers 108 increase the voltage from that produced by the power plants 102, 104 to a high voltage, such as 138 kV for example, to allow long distance transmission of the electric power over the main transmission system 106. It shall be appreciated that additional components such as, transformers, switchgear, fuses and the like (not shown) may be incorporated into the system 100 as needed to ensure the safe and efficient operation of the system.

The system 100 is typically interconnected with one or more other systems to allow the transfer of electrical power into or out of the system 100. At time of high demand, the system 100 can receive electric power from other plants (not shown) to meet the demand. Similarly, at times when demand is below capacity, the system 100 provides electric power to other systems, if needed. The power plants 102, 104 and the main transmission system 106 can collectively be referred to as a production network 110.

The main transmission system 106 typically consists of high voltage transmission power lines, anywhere from 69 KV to 500 KV for example, and associated transmission and distribution equipment which carry the electrical power from the point of production at the power plants 102, 104 to a distribution network 112. The distribution network 112 can include one or more distribution substations 114, 116, 118 and distributes electrical power from the production network 110 to end users such as consumers 124 and 126, for example.

The distribution substations 114, 116, 118 reduce the transmission voltage to distribution levels such as 13 KV, 27 KV or 33 KV for the end users. Distribution substations 114, 116, 118 can include one or more transformers, switching, protection and control equipment as well as circuit breakers to interrupt faults such as short circuits or over-load currents that may occur. The distribution substations 114, 116, 118 may also include equipment such as fuses, surge protection, controls, meters, capacitors, load tap changers and voltage regulators.

It should be appreciated that each of the distribution substations 114, 116, 118 may be connected to a single power plant, such as first power plant 102 for example. Alternatively, the distribution substations 114, 116, 118 may be connected to the main transmission system 106 such that they receive electrical power from different power stations.

The distribution substations 114, 116, 118 can connect to one or more local electrical distribution networks 120. The local networks 120 provide electrical power to an area, such as a residential area for example. The local networks 120 can include one or more branches as is know in the art. For ease of explanation, only distribution substation 118 is discussed further herein but it shall be understood that the following explanation can apply to any of the distribution substations 114, 116, 118.

The local network 120 coupled to distribution substation 118 is also connected to additional equipment, such as distribution transformers 122, that adapt the voltage from that output by the substation 118 to voltage usable by end consumers, such as first end consumer 124 and second end consumer 126. For example, the substation 118 may distribute electrical power at 13 kV. The transformers 122 lower the voltage to 120V/208V, which is usable by a residence. The local electrical distribution network 120 may further have isolated end consumers such as an office building or a manufacturing facility (not shown). The number of consumers 124, 126 that can be coupled to the local electrical distribution network 120 can vary.

Each node (e.g., distribution substation 118 or nodes in the main transmission system 106) can have a rated capacity. The rated capacity represents the amount of power that can safely pass through a particular node. It shall be understood that the capacity value used herein can actually be a set point that is based of the rated capacity and, as such, the term “set point” where referring to a node can mean either the rated capacity (i.e., what the node can handle) or a value based off the rated capacity. When the rated capacity of the node is nearly or actually reached, congestion exists at that node.

One or more of the consumers (e.g., first consumer 124 and second consumer 126) connected to a particular distribution substation 118 can include one or more power consuming devices 128. The power consuming devices 128 can include, for example, refrigerators, air conditioners, clothes washer and dryers and the like. In one embodiment, the power consuming devices 128 are “smart” devices and the distribution network 112 is a smart grid. A smart grid is a form of electricity network utilizing digital technology. A smart grid delivers electricity from suppliers (e.g., plants 102, 104) to consumers (e.g., consumers 124, 126) and includes two-way digital communications to control or monitor devices at consumers' homes. To that end, the power consuming devices 128 can include smart meters either within themselves or can, optionally, be connected to one or more premise wide smart meters 130.

According to one embodiment, the system 100 includes a pricing monitor 140. In general, the pricing monitor 140 monitors the loads at nodes of the system 100. When congestion is encountered the pricing monitor 140 can impose congestion pricing on consumers 124, 126. The congestion pricing will typically be greater than a standard price for the power. Additional penalties can also be levied on consumers 124, 126 if they exceed certain thresholds during times of congestion pricing. In one embodiment, those who do reduce consumption may receive a credit that serves to offset the congestion pricing. In one embodiment, the amount of increased cost carried by consumers during congestion pricing (possibly including penalties) is balanced by the credits given to consumers that reduce their consumption. Stated differently, any increase in revenue realized by the power provider due to congestion pricing, penalties, or both, can be returned to consumers in the form of credits. In this manner, those who reduce consumption to reduce congestion can be rewarded.

The smart meters 130 or the smart devices 128 (or both) may include the capability for a user to set a limit on the price the user is willing to pay for power (electricity) to operate a particular machine. For example, assume that one of the smart devices 128 is a clothes dryer. The user can set an upper limit on the cost per hour (for example) the user is willing to pay to operate the dryer. In one embodiment, the pricing monitor 140 communicates a price for electricity to the smart device 128. If the price is below the upper threshold, the smart device 128 can operate. If, however, smart device 128 is operating when congestion pricing is communicated to the smart device 128 that exceeds the upper threshold, the smart device 128 may stop operating. In this manner, the user (e.g. consumers) sets the price which will cause them to shed load. The upper threshold can also provide a means for load scheduling of smart devices to times when power has a reduced cost.

Accordingly, a technical effect of the present invention is that it allows consumers to control load shedding. Another technical effect is that congestion pricing (e.g., a congestion surcharge, a penalty, or both) can be balanced by credits given to those who shed load during times of congestion.

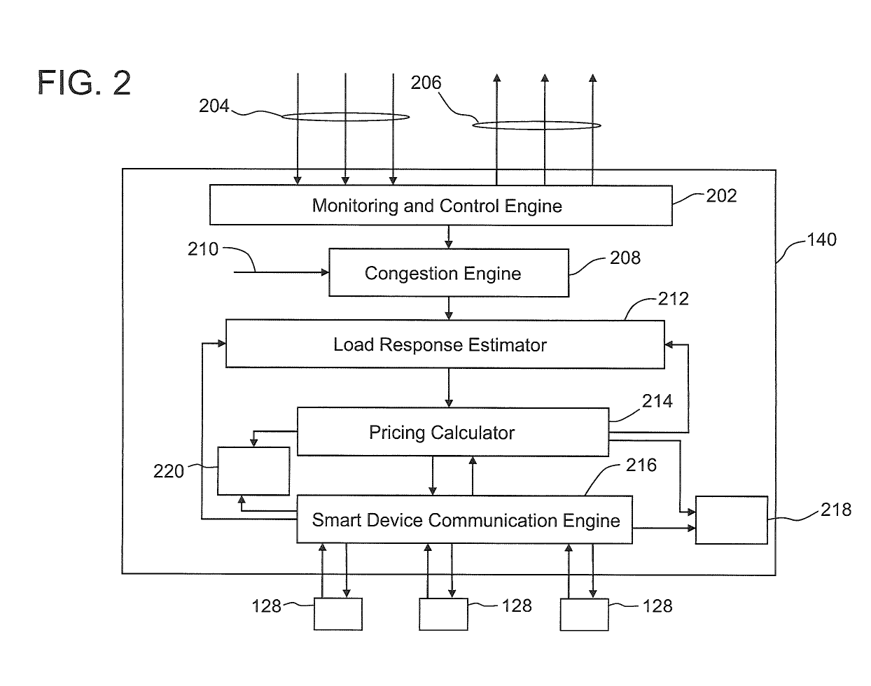

FIG. 2 is a block diagram of a pricing monitor 140 according to one embodiment of the present invention. The pricing monitor 140 can be implemented on one or more different computing devices. In general, the pricing monitor 114 provides a link between monitored conditions of a distribution network (e.g., distribution system 112) and a distribution-pricing scheme that can be used to affect the load on the distribution network. That is, the pricing monitor 140 can cause prices during congestion to increase until consumers are motivated to shed load and, thereby, to reduce congestion. In addition, the pricing monitor 140 can also impose additional penalties on consumers who exceed a usage threshold during times of congestion.

The illustrated pricing monitor 140 includes a monitoring and control engine 202. The monitoring and control engine 202 can receive power consumption (load) and other values 204 from a distribution network and issue control commands 206 to the network. In one embodiment, the monitoring and control engine 202 is part of a supervisory control and data acquisition (SCADA) system. Such systems are known in the art and are not discussed further herein. In one embodiment, the monitoring and control engine 202 receives the load or other values 204 from multiple nodes in a distribution network. The nodes can be at varying levels in one embodiment. For example, one node can be at a distribution substation and have several nodes coupled downstream of it. The downstream nodes can be located, for example, at the start of each branch that extends from the distribution substation and each branch can include a node at each distribution transformed coupled to the branch.

Regardless of the particular configuration, the load at one or more of the nodes is provided to congestion engine 208. The congestion engine 208 is configured to determine whether an actual or predicted load at any of the nodes exceeds or is predicted to exceed the capacity at the node. If either the actual or predicted load exceeds the capacity, the congestion engine 208 can identify that an actual or future congestion situation exists.

The congestion engine 208 can include, in one embodiment, tables or other data representing the rated capacity for some or all of the nodes in the distribution network. In one embodiment, for each node the rated capacity is compared to a current load to determine if an actual congestion situation exists. In another embodiment, the congestion engine 208 can receive an input 210 that provides an environmental input value that can be used to generate a forecasted load that may occur in the future. The environmental input value can be a daily high temperature in one embodiment. In such an embodiment, the input 210 can also include an expected time of the daily high temperature. The time may be important because it has been discovered that energy usage, generally, increases with temperature. As such, the time when the high temperature occurs can predict when the most power will be consumed. In this embodiment, the forecasted load can also include general usage information such as average usage at an average temperature at a specific time. Such general usage can take into account varying loads on the network due to, for example, individuals returning from work and starting to do laundry at the end of the day. In the event that the forecasted load at a node exceeds the rated capacity at the node, the congestion engine can indicate that congestion may occur in the future. General usage information can also include some specific date related information that can affect consumption including, for example, special events such as holidays or major sporting events like the Superbowl or World Cup games.

Regardless of whether the congestion is actual or expected, an amount of congestion (or related value) experienced at one or more nodes in the network is provided from the congestion engine 208 to a load response estimator 212. In general, the load response estimator 212 estimates load responsiveness to price increases to form a load response curve. In one embodiment, the load response curve relates an amount of congestion reduction based on an amount of price increase. The load response curve can be formed based off of prior information in some cases. For example, if a prior x % increase resulted in y % decrease in usage at a specific temperature, those values could be interpolated to the current situation. Furthermore, each node can have its own load response curve to take in to account variations in demographics and the number or type of consumers, for example, which may be affected. It shall be understood that because the smart devices 128 can communicate with the pricing monitor 140, the load response curve can also take into account the responses of one or more individual devices to a particular price increase.

Based on the load response curve, an initial congestion price can be established by a pricing calculator 214. The pricing calculator 214 selects a new price for power provided to the node. This new price will be established in such a manner that it is expected to cause the load to drop below the rated capacity of the node. The new price is then communicated to consumers on the node by a smart device communication engine 216. It shall be understood that the load response estimator 212 can continually or periodically check to see if current pricing has led to the desired result. If not, the load response curve can be adapted to more accurately reflect actual conditions.

In one embodiment, those consumers having devices that reduce consumption during times of congestion can be issued a credit by a credit calculator 218. The credit calculator 218 can generate the credit based on a consumer usage threshold in one embodiment. This threshold can be established in several different manners. For example, the threshold can be set as one of: the load used by the consumer at the time that congestion pricing began, an average premise load profile, an average of comparable consumer consumption, or an arbitrary value. Regardless of how the threshold is set, if the usage during congestion by a particular consumer is less than the threshold, that consumer can be issued a credit.

The amount of the credit can be determined in several different ways. For example, the credit can be a flat amount or be based on the amount of power below the threshold that was used during the time of congestion pricing. In one embodiment, the sum of all of the credits issued to consumers attached to a particular node is set such that it balances a congestion related revenue increase due to the raised price charged for providing power to the node during times of congestion. Of course, the same could be true at every node and for the distribution system as a whole.

Optionally, the pricing monitor 140 can include a penalty calculator 220. The penalty calculator 220 can impose an additional penalty beyond the increased price set during times of congestion on consumers that exceed their threshold. In such an embodiment, the sum of all of the credits issued to consumers attached to a particular node is set such that it balances a congestion related revenue increase due to the raised price generally charged during times of congestion and the penalties. Similar to the credits, the amount of the penalties can be fixed, or based on an amount of usage above the threshold during congestion pricing, for example.

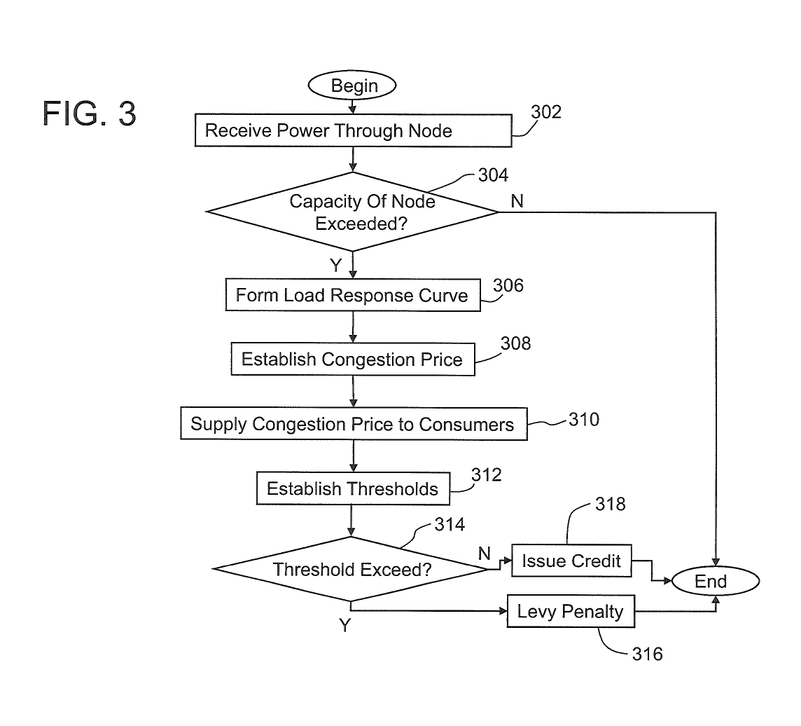

FIG. 3 illustrates a method 300 according to one embodiment. The method 300 can be carried out, for example, by the pricing monitor 140 illustrated in FIG. 2. The method 300 shown in FIG. 3 can be carried out for each node in a distribution network. In one embodiment, the furthest downstream nodes are processed first and then nodes closer to the power production are processed to take into account the effects of congestion pricing at the downstream nodes.

The method begins at block 302 where either or both of the instantaneous and forecasted power through one or more nodes is received. The following explanation will focus only on the instantaneous load but it shall be understood that the predicted load could be used in the same manner as described below except that the congestion pricing is applied at a future time.

At block 304 it is determined if the received power through the node exceeds the rated capacity of the node. If it does not, the method ends. If it does, processing moves to block 306. At block 306 a load response curve as described above is created. From the load response curve, a congestion price for power is created at block 308. The congestion price is selected, in one embodiment, such that it will cause consumption to be reduced below the rated capacity of the node. At block 310 the congestion price is supplied to the consumers.

At block 312 consumption thresholds to apply during congestion pricing for each consumer are either calculated or retrieved. As described above, the consumption threshold can be formed in several different manners. At block 314 current consumption of each consumer is compared to the threshold assigned to them. If the threshold is exceeded, an optional penalty may be imposed as indicated at block 316. If, however, the consumption is less than the threshold, the consumer is issued a credit at block 318. In one embodiment, the sum of the amount of all the credits is equal to the amount of increased revenue due to congestion pricing.

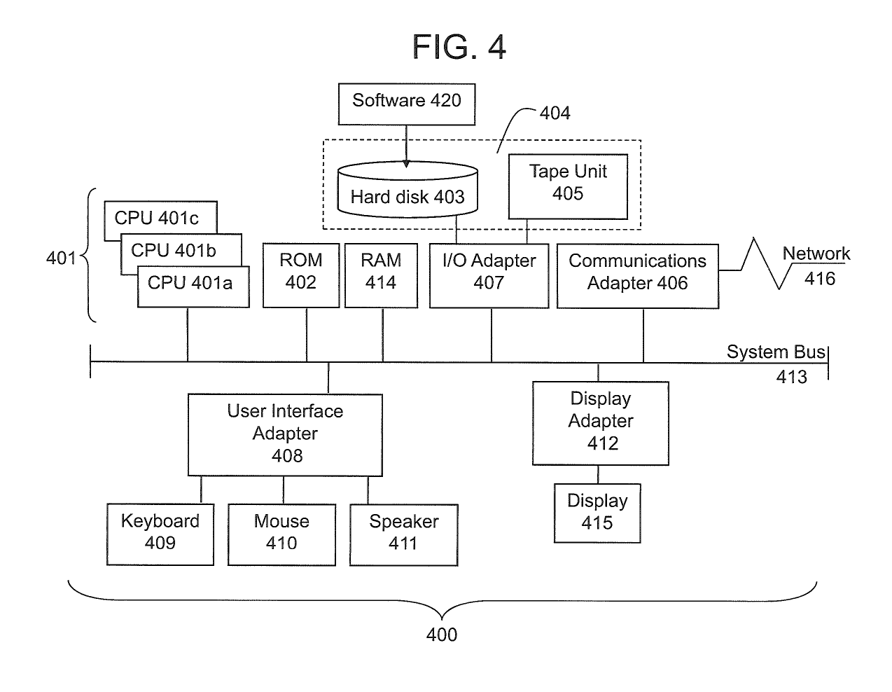

FIG. 4 shows an example of a computing system 400 on which embodiments of the present invention may be implemented. The system 400 illustrated in FIG. 4 includes one or more central processing units (processors) 401a, 401b, 401c, etc. (collectively or generically referred to as processor(s) 401). Processors 401 are coupled to system memory 414 (RAM) and various other components via a system bus 413. Read only memory (ROM) 402 is coupled to the system bus 413 and may include a basic input/output system (BIOS), which controls certain basic functions of system 400.

FIG. 4 further depicts an input/output (I/O) adapter 407 and a network adapter 406 coupled to the system bus 413. I/O adapter 407 may be a small computer system interface (SCSI) adapter or any other type of adapter that communicates with a hard disk 403 and/or tape storage drive 405 or any other similar component. I/O adapter 407, hard disk 403, and tape storage device 405 are collectively referred to herein as mass storage 404. In one embodiment, the mass storage 404 and the system memory 414 can collectively be referred to as memory, and can be distributed across several computing devices.

A network adapter 406 interconnects bus 413 with an outside network 416 enabling system 400 to communicate with other such systems. A screen (e.g., a display monitor) 415 is connected to system bus 413 by display adaptor 412. The system 400 also includes a keyboard 409, mouse 410, and speaker 411 all interconnected to the bus 413 via user interface adapter 408.

It will be appreciated that the system 400 can be any suitable computer or computing platform or specialized device, and may include a terminal, wireless device, information appliance, device, workstation, mini-computer, mainframe computer, personal digital assistant (PDA) or other computing device. It shall be understood that the system 400 may include multiple computing devices linked together by a communication network. For example, there may exist a client-server relationship between two systems and processing may be split between the two.

As disclosed herein, the system 400 includes machine-readable instructions stored on machine readable media (for example, the hard disk 404) causing the system to perform one or more of the methods disclosed herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for implementing congestion pricing in a power distribution network, the system comprising:
a monitoring and control engine configured to receive an actual power consumption value for a node in the power distribution network;
a congestion engine coupled to the monitoring and control engine configured to determine that a power consumption value exceeds a capacity related set point of the node;
a pricing calculator that establishes a congestion price for power provided at the node to be applied while the actual power consumption value exceeds the set point of the node; and
a credit calculator that provides credits to consumers coupled to the node that consume power at a rate below a threshold while the actual power consumption value exceeds the set point of the node.

2. The system of claim 1, wherein the monitoring and control engine is a supervisory control and data acquisition (SCADA) system.

3. The system of claim 1, wherein the power consumption value is the actual power consumption value.

4. The system of claim 3, wherein the pricing calculator establishes the congestion price at a level predicted to cause the actual power consumption value to fall below the set point of the node.

5. The system of claim 1, wherein the power consumption value is an estimated or predicted power consumption value.

6. The system of claim 5, wherein the congestion engine receives an environmental input or specific date related information and determines a time when the power consumption value will exceed the set point of the node based on the environmental input, the specific date related information or both.

7. The system of claim 6, wherein the environmental input is a daily high temperature

8. The system of claim 1, wherein the credit calculator provides credits such that the value of the credits equals an increase in revenue due to the congestion price.

9. The system of claim 1, further comprising:
a penalty calculator that levies penalties on consumers that consume power at a rate above the threshold while the actual power consumption value exceeds the set point of the node.

10. The system of claim 9, wherein the credit calculator provides credits such that the value of the credits equals an increase in revenue due to the congestion price and the penalties.

11. The system of claim 1, further comprising:
a load response estimator coupled to the congestion engine that creates a load response curve; and
wherein the pricing calculator establishes the congestion price based on the load response curve.

12. A method for implementing congestion pricing in a power distribution network, the method comprising:
receiving an actual power consumption value for a node in the power distribution network;
determining that a power consumption value exceeds a capacity related set point of the node;
establishing a congestion price for power provided at the node to be applied while the actual power consumption value exceeds the set point of the node; and
providing credits to consumers that consume power at a rate below a threshold while the actual power consumption value exceeds the set point of the node.

13. The method of claim 1, further comprising:
creating a load response curve; and
wherein the congestion price is established based on the load response curve.

14. The method of claim 12, wherein the congestion price is established at a level predicted to cause the actual power consumption value to fall below the set point of the node.

15. The method of claim 12, wherein credits are provided such that the value of the credits equals an increase in revenue due to the congestion price.

16. The method of claim 12, further comprising:
levying penalties on consumers that consume power at a rate above the threshold while the actual power consumption value exceeds the set point of the node.

17. The method of claim 16, wherein credits are provided such that the value of the credits equals an increase in revenue due to the congestion price and the penalties.
